(19) United States
(12) Patent Application Publication
(10) Pub. No.: US 2008/0076399 A1
(43) Pub. Date: Mar. 27, 2008

(54) METHOD FOR SEARCHING FOR INFORMATION IN MOBILE TERMINAL

(75) Inventor: Byung Jik JEGAL, Goyang-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/858,009

(22) Filed: Sep. 19, 2007

(30) Foreign Application Priority Data
Sep. 21, 2006 (KR) 2006-0091574

(51) Int. Cl. H04L 29/06

(52) U.S. Cl. 455/414.3

(57) ABSTRACT

Provided is a method for searching for information in a mobile terminal. The method includes designating a search location at a search mode; if a search word input in the search mode is a place search word, for places corresponding to the place search word; and displaying found places according to a preset priority. The method includes retrieval of information through a retrieval system connected to the mobile terminal via a network, display of the information through analysis in such a manner that the user can easily identify the information and, delivery of an information related service according to the user's request, thus allowing users to easily use a search service.

### PRIORITY

This application claims priority under U.S.C. §119(a) to an application entitled “METHOD FOR SEARCHING FOR INFORMATION IN MOBILE TERMINAL” filed in the Korean Intellectual Property Office on Sep. 21, 2006 and assigned Serial No. 2006-0091574, the contents of which are incorporated herein by reference.

### BACKGROUND OF THE INVENTION

1. Field of the Invention

The present invention relates to a method for searching for information in a mobile terminal, and more particularly, to a method for searching for information related to a specific place or person in the mobile terminal.

2. Description of the Related Art

Mobile terminals are rapidly permeating into all aspects of our daily lives and provide communication functions, as well as diverse additional functions. That is, a current mobile terminal supports an increasing number of functions to meet changing user demands and store large amounts of information. For example, the information may include phone numbers stored in a phone book and photos stored in a photo album.

In order to search for a phone number of a specific place or person in a mobile terminal, the phone number should be pre-stored in the mobile terminal by a user. If not, the user of the mobile terminal has to call a phone-number information service or use an Internet service to obtain the desired phone number.

However, a conventional phone-number information service available to a caller is limited to providing information about phone numbers assigned to wired telephone services. Further, the Internet service provides a list of all phone numbers related to a specific place or person, and hence the list of all phone numbers may be excessively long. Thus, it is difficult and burdensome to search for a phone number of a specific place or person in a mobile terminal.

### SUMMARY OF THE INVENTION

In order to solve the above problems, the present invention provides a method for easily searching for a phone number of a place or person in a mobile terminal.

The present invention also provides a method for easily searching for information related to a place or person in a mobile terminal.

The present invention also provides a method for searching for information in a mobile terminal that enables information about a place or person to be displayed through analysis of the information in such a manner that a user can easily identify the place or person.

In accordance with the present invention, a method is provided for searching for information in a mobile terminal, including designating a search location in a search mode; if a search word input at the search mode is a place search word, searching for places corresponding to the place search word; and displaying the found places according to a preset priority.

In accordance with the present invention, a method is provided for searching for information in a mobile terminal, including if a place search word is input at a search mode, transmitting the place search word to a retrieval system via a network; displaying found place information received from the retrieval system; and if the displayed place information is selected, performing a communication service using the selected place information.

### BRIEF DESCRIPTION OF THE DRAWINGS

The objects, features and advantages of the present invention will be more apparent from the following detailed description in conjunction with the accompanying drawings, in which:

FIG. 1 is a schematic block diagram illustrating a configuration of a retrieval system using a mobile terminal according to an exemplary embodiment of the present invention;

FIG. 2 is a schematic block diagram illustrating a configuration of a mobile terminal according to an exemplary embodiment of the present invention;

FIG. 3 is a flowchart illustrating a method for searching for information in a mobile terminal according to an exemplary embodiment of the present invention; and

FIG. 4 is a flowchart illustrating a method for searching for information in a mobile terminal according to another exemplary embodiment of the present invention.

### DETAILED DESCRIPTION OF EXEMPLARY EMBODIMENTS

Hereinafter, exemplary embodiments of the present invention are described in detail with reference to the accompanying drawings.

In the embodiments below, “information” refers to information that can be searched for in a mobile terminal as required by a user. A “place” is classified by trade name and activity type and refers to a specific entity or locality at which an activity occurs. Examples of places classified by activity type may include restaurants, hospitals, and parks. “Location information” refers to a spatial location at which a place is positioned and is used to determine a distance and movement path between the place in a search location and a mobile terminal.

“Preference information” refers to a degree of preference for a place acquired from place users and visitors. For example, preference information may be obtained based on the number of receptions of phone calls for the place, the number of people who access a website for the place, and place users' opinions on the place. “Place information” refers to information about a place that may include the location information, preference information, a trade name, an activity type, a phone number, and photos. “Person” refers to a specific person identified by a name entered by the user of the mobile terminal. “People information” refers to personal information about the specific person, such as a name, a gender, an age, a phone number, an address, and photos.

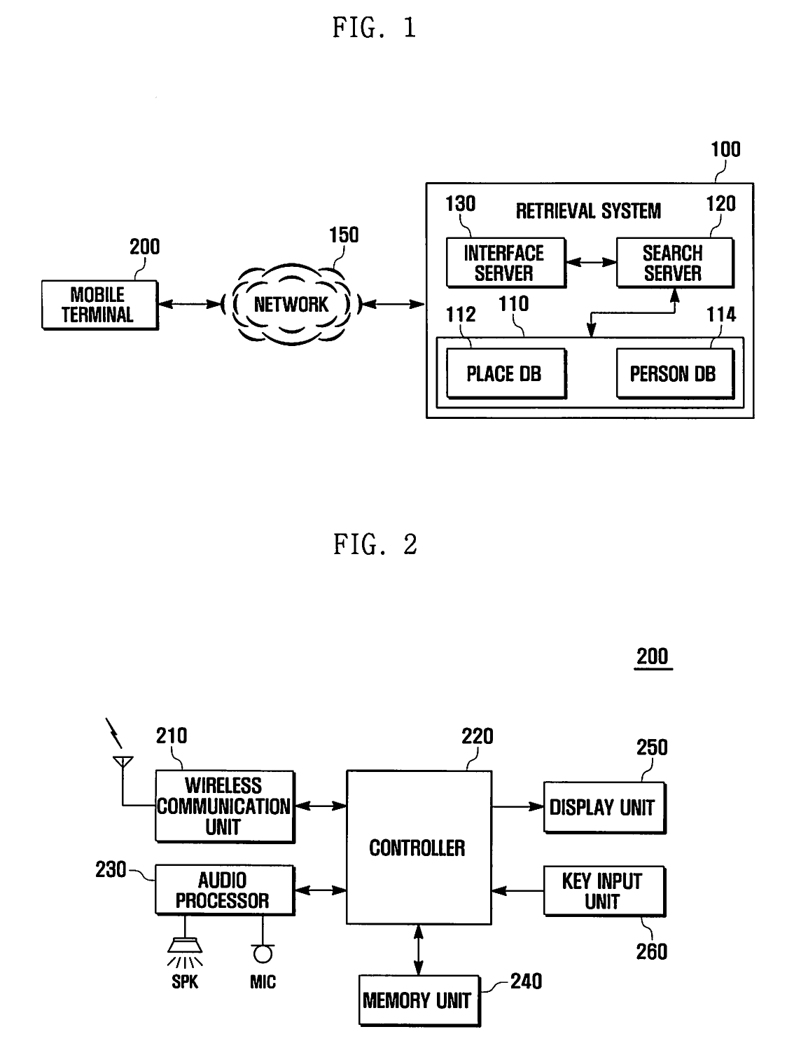

FIG. 1 is a schematic block diagram illustrating a configuration of a retrieval system 100 using a mobile terminal according to an exemplary embodiment of the present invention.

Referring to FIG. 1, the retrieval system 100 is connected to a plurality of mobile terminals 200 via a network 150. The network 150 may be any type of network that includes mobile Internet, such as a Wireless Broadband (WiBro) network or a Wireless Fidelity (WiFi) network.

Each mobile terminal 200 is a communication device that can be connected to the retrieval system 100 through the network 150. For example, the mobile terminal 200 may be an Internet-connectable wireless communication terminal. In particular, upon receipt of a search service request from a user, the mobile terminal 200 according to the present embodiment designates a search location, as its current location, and then searches for information associated with a search word entered by the user. In this case, the mobile terminal 200 detects the current location using a Global Positioning System (GPS) or using the location of a cell to which the current location belongs through a wireless communication network or mobile Internet.

The retrieval system 100 provides the mobile terminal 200 with a search service via the network 150. The retrieval system 100 includes a DataBase (DB) server 110, a search server 120, and an interface server 130.

The DB server 110 stores information to be provided to the mobile terminal 200. In particular, the DB server 110 includes a place DB 112 for storing information about places and a person DB 114 for storing information about people. Information about a place is stored in the place DB 112 according to a request from a place's representative. Information about a person is stored in the person DB 114 according to the person's request.

The search server 120 searches the DB server 110 based on a search word received from the mobile terminal 200. The search server 120 extracts information that matches the search word from the DB server 110.

The interface server 130 is actually connected to the mobile terminal 200 via the network 150. More specifically, the interface server 130 receives the search word from the mobile terminal 200 and transmits the search word to the search server 120. The interface server 130 also converts information extracted through the search server 120 to match a communication protocol and transmits the result to the mobile terminal 200.

FIG. 2 is a schematic block diagram illustrating a configuration of a mobile terminal capable of searching for information about a place or person according to an exemplary embodiment of the present invention.

Referring to FIGS. 1 and 2, the mobile terminal 200 includes a wireless communication unit 210, a controller 220, an audio processor 230, a memory unit 240, a display unit 250, and a key input unit 260.

The wireless communication unit 210 performs wireless communications of the mobile terminal 200. The wireless communication unit 210 includes a Radio Frequency (RF) transmitter that up-converts the frequency of a signal to be transmitted and amplifies the signal, and an RF receiver that low-noise amplifies a received signal and down-converts its frequency. In particular, according to the present embodiment, the wireless communication unit 210 transmits a search word entered by the user of the mobile terminal 200 to the retrieval system 100 via the network 150, and receives information corresponding to the search word from the retrieval system 100 via the network 150.

The controller 220 controls the overall operation of the mobile terminal 200. The controller 220 includes a data processor (not shown) consisting of a transmitter that encodes and modulates a signal for transmission and a receiver that demodulates and decodes a received signal. In this case, the data processor may include a MOdulator/DEModulator (modem) and a COder/DECoder (codec). The controller 220 also detects a current location through the wireless communication unit 210 and controls connection/disconnection to the network 150.

Further, if the search word is related to a place, the controller 220 analyzes place information corresponding to the search word, extracted from the place DB 112, and controls the display unit 250 to display the found places according to a preset priority. Further, the controller 220 controls the display unit 250 to display a list of the places or to display the places on a map indicating the current location, as a region that is completely within a predetermined distance from the location of the mobile terminal 200. The controller 220 also controls the operation of the mobile terminal 200 to provide a service regarding a place that is selected by the user from among the places according to the user's request.

Further, if the search word is related to a person, the controller 220 controls the display unit 250 to display people based on person information extracted from the person DB 114. The controller 220 controls the operation of the mobile terminal 200 to provide a service regarding a person that is selected by the user from among the people according to the user's request.

The audio processor 230 reproduces an audio signal received from an audio codec (not shown) of the data processor through a SPeaKer (SPK), and outputs an audio signal input through a MiCrophone (MIC) to the audio codec of the data processor.

The memory unit 240 includes a program memory and a data memory. The program memory is used to store programs for controlling the operations of the mobile terminal 200 and programs for searching for information related to a place or person according to the present embodiment. The data memory is used to store data generated while executing the programs.

The display unit 250 is controlled by the controller 220 to display a status of the mobile terminal 200. The display unit 250 may be a Liquid Crystal Display (LCD). In this case, the display unit 250 includes an LCD controller, a memory for storing display data, and an LCD display element (not shown). If the LCD is implemented using a touch screen technology, the screen of the display unit 250 may also function as an input portion.

The key input unit 260 includes keys for inputting numerals and characters and function keys for setting various functions.

In the above description, the location of the mobile terminal 200 is detected through a wireless communication network, however the location of the mobile terminal 200 may be determined using a GPS, a mobile Internet connection, or a wireless Internet connection. For example, if the mobile terminal 200 includes a GPS unit for receiving GPS information or a mobile Internet unit for transmitting and receiving an Internet signal, the location of the mobile terminal 200 may be determined by the GPS unit or the mobile Internet unit.

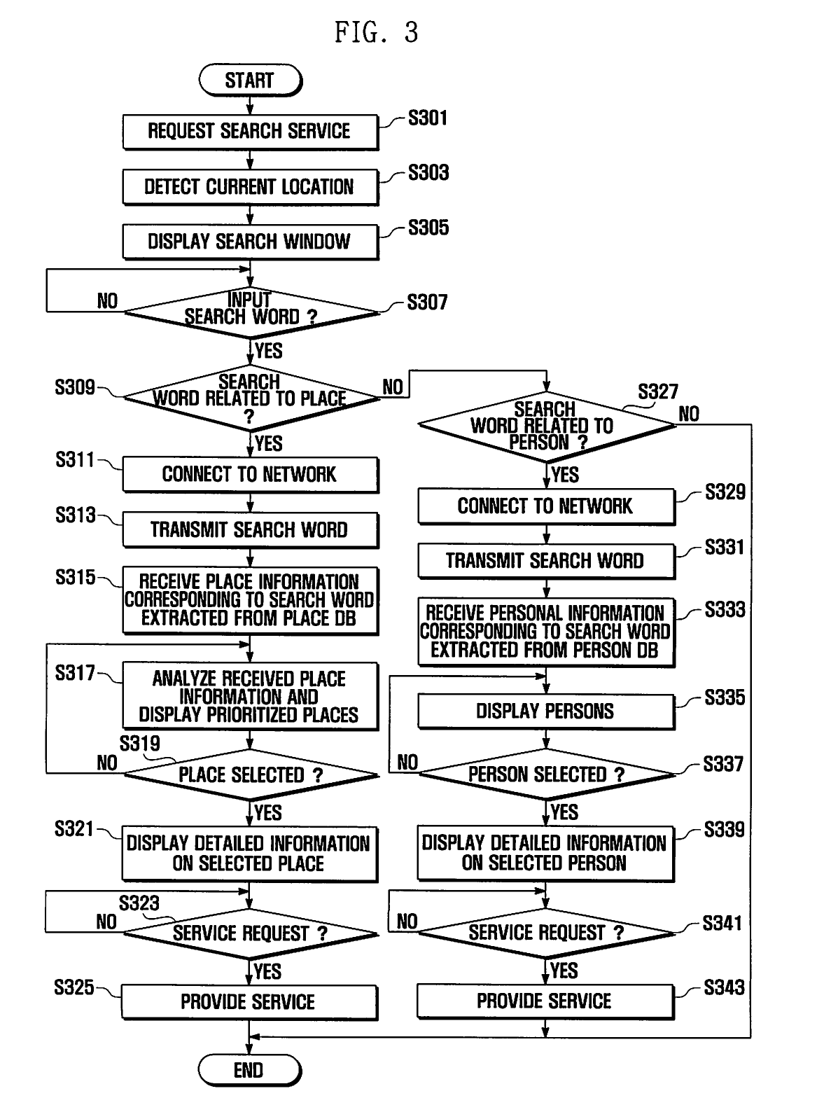

FIG. 3 is a flowchart illustrating a method for searching for information in a mobile terminal according to an exemplary embodiment of the present invention.

Referring to FIGS. 1 through 3, the method for searching for information in the mobile terminal 200 begins when the controller 220 receives a search service request signal from a key input unit 260 through a function key (or hot key) or menu, in step S301. The controller 220 then designates a search location, as a location of the mobile terminal 200, in step S303, and controls the display unit 250 to display a search window, in step S305. If the controller 220 determines that a search word is entered by the user of the mobile terminal 200 into the search window, in step S307, the controller 220 determines whether the search word is related to a place, in step S309. The search word related to a place may include the search location and the trade name or the activity type, or may be the trade name or the activity type.

If the search word is related to a place at step S309, the controller 220 controls the wireless communication unit 210 to connect to the network 150, in step S311. The controller 220 then controls the wireless communication unit 210 to transmit the search word to the retrieval system 100 via the network 150, in step S313. If the search word is the trade name or the activity type, the controller 220 may transmit the current location and the trade name or the activity type. If the search word includes the search location and the trade name or the activity type, the controller 220 may transmit the search location and the trade name or the activity type. The retrieval system 100 extracts place information in the search location corresponding to the search word from the place DB 112 and transmits the place information to the mobile terminal 200, and the wireless communication unit 210 receives the place information extracted from the retrieval system 100, in step S315.

The controller 220 analyzes the place information and controls the display unit 250 to display the places according to a preset priority, in step S317. For example, the controller 220 may control the display unit 250 to display the places in order from a nearest to a farthest place location from the location of the mobile terminal 200 based on location information contained in the place information. The controller 220 may control the display unit 250 to display the places in order of a highest to a lowest preference based on preference information contained in the place information. The controller 220 may control the display unit 250 to display places that are located completely within a predetermined distance from the location of the mobile terminal 200 in order of a highest to a lowest preference based on a combination of the location information and the preference information. Further, the controller 220 may control the display unit 250 to display a list of the places or to display the places on a map indicating the search location, as a region that is completely within a predetermined distance from the location of the mobile terminal 200.

If the controller 220 determines that one of the places is selected by the user, in step S319, the controller 220 controls the display unit 250 to display detailed information on the selected place, such as a trade name, an activity type, a phone number, an address, photos, and a website, in step S321. In this case, the detailed information on the selected place may be optionally input by the place's representative when place information is stored upon request of the representative.

If the controller 220 determines that a service request is input by the user of the mobile terminal 200 at step S321, in step S323, the controller 220 provides the service to the user, in step S325. Examples of the service may include making a phone call connection, accessing a website, ordering a product, displaying a map containing the place, and guiding a movement path from the location of the mobile terminal 200 to the place in the search location. It is also possible to display a map indicating a region that is completely within a distance from the current location, greater than the predetermined distance.

If the search word is not related to a place at step S309, the controller 220 determines whether the search word is related to a person, in step S327. If the search word is not related to a person, the controller 220 terminates the search service. If the search word is related to a person, the controller 220 controls the wireless communication unit 210 to connect to the network 150, in step S329. The controller 220 transmits the search word to the retrieval system 100 via the network 150, in step S331. The retrieval system 100 extracts person information corresponding to the search word from the person DB 114 and transmits the person information to the mobile terminal 200, and the controller 220 receives the person information extracted from the retrieval system 100, in step S333.

The controller 220 controls the display unit 250 to display people according to the received person information. In this embodiment, the display unit 250 displays a list of the people according to a preset priority. For example, the controller 220 controls the display unit 250 to display the list of people according to at least one of a residential region, an age, and a gender contained in the person information. The controller 220 may also control the display unit 250 to display the list together with a thumbnail photo of each person.

If the controller 220 determines that one of the people is selected by the user, in step S337, the controller 220 controls the display unit 250 to display detailed information on the selected person, such as a name, a gender, an age, a phone number, an address, photos, and an e-mail address, in step S339. In this case, the detailed information on the selected person may be optionally input by the person when personal information is stored upon their request.

If the controller 220 determines that a service request is input by the user of the mobile terminal 200 at step S339, in step S341, the controller 220 provides the service to the user, in step S343. Examples of the service may include making a phone call connection, transmitting a text message, sending an e-mail message, and displaying a photo.

In the above embodiment, the mobile terminal user searches for information via the Internet, however in another exemplary embodiment, the user can search for information in a mobile terminal having a place DB. That is, the place DB may be embedded within the mobile terminal 200 or externally installed.

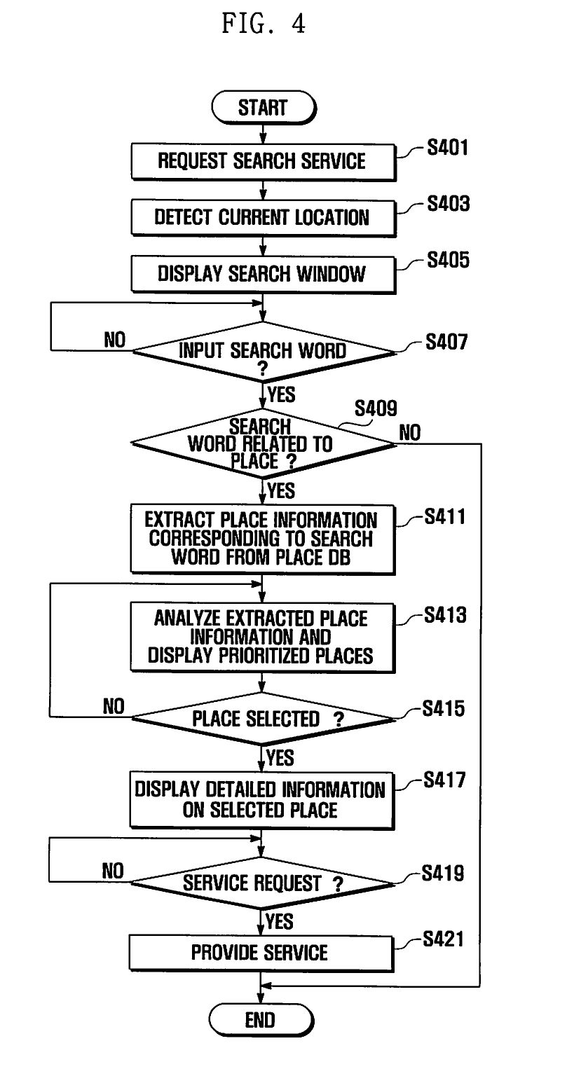

FIG. 4 is a flowchart illustrating a method for searching for information in a mobile terminal according to another exemplary embodiment of the present invention.

Referring to FIG. 4, the method for searching for information in the mobile terminal begins when a controller 220 receives a search service request signal, in step S401. The controller 220 then designates a search location, as a current location, in step S403 and controls a display unit 250 to display a search window, in step S405. If the controller 220 determines that a search word is entered by the user of the mobile terminal 200 into the search window, in step S407, the controller 220 determines whether the search word is related to a place, in step S409.

If the search word is not related to a place, the controller 220 terminates the search service. If the search word is related to a place, the controller 220 extracts place information in the search location corresponding to the search word from the place DB, in step S411.

The controller 220 analyzes the place information and controls the display unit 250 to display the places according to a preset priority, in step S413. For example, the places may be displayed in order from a nearest to a farthest place location from a location of the mobile terminal 200 based on location information contained in the place information. A list of the places may be displayed or the places may be displayed on a map indicating the search location, as a region that is completely within a predetermined distance from the location of the mobile terminal 200.

If the controller 220 determines that one of the places is selected by the user, in step S415, the controller 220 controls the display unit 250 to display detailed information on the selected place, such as trade name, activity type, phone number, address, photos, and website, in step S417. In this case, the detailed information on the selected place may be optionally input by the place's representative when place information is stored upon request of the representative.

If the controller 220 determines that a service request is input by the user of the mobile terminal 200 at step S417, in step S419, the controller 220 provides the service to the user, in step S421. Examples of the service may include making a phone call connection, accessing a website, ordering a product, displaying a map containing the place, and guiding a movement path from the location of the mobile terminal 200 to the place in the search location. It is also possible to display a map indicating a region that is completely within a distance from the current location greater than the predetermined distance.

As described above, a method for searching for information in a mobile terminal according to the present invention enables retrieval of information through a retrieval system connected to the mobile terminal via a network. The present invention also enables display of the information through analysis in such a manner that the user can easily identify the information and enables delivery of an information related service according to the user's request, thus enabling users to easily use a search service.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for searching for information in a mobile terminal, the method comprising:
designating a search location at a search mode;
if a search word input at the search mode is a place search word, searching for places corresponding to the place search word; and
displaying found places according to a preset priority.

2. The method of claim 1, wherein searching for places corresponding to the place search word comprises:
if the place search word is input, connecting to a network;
transmitting the place search word to a retrieval system via the network; and
receiving place information corresponding to the place search word extracted from the retrieval system.

3. The method of claim 2, wherein the priority for each place is determined according to location information contained in the place information and wherein each place has a higher priority the nearer the place is to a location of the mobile terminal.

4. The method of claim 2, wherein the priority for each place is determined according to preference information contained in the place information and wherein each place has a higher priority as the place's preference becomes higher.

5. The method of claim 1, wherein the found places are displayed as a list.

6. The method of claim 1, wherein the found places are displayed on a map

7. The method of claim 1, further comprising if one of the displayed places is selected, displaying detailed information about the selected place.

8. The method of claim 7, further comprising if a request for a service is input while displaying the detailed information, displaying the requested service.

9. The method of claim 1, further comprising:
if a search word input at the search mode is a person search word, searching for people corresponding to the person search word; and
displaying found people according to a preset priority.

10. The method of claim 9, wherein searching for people corresponding to the person search word comprises:
if the person search word is input, connecting to a network;
transmitting the person search word to a retrieval system via the network; and
receiving person information corresponding to the person search word extracted from the retrieval system.

11. The method of claim 10, wherein the priority for each person is determined according to at least one of a residential region, an age, and a gender contained in the person information.

12. The method of claim 9, further comprising if one of the displayed people is selected, displaying detailed information about the selected person.

13. The method of claim 12, further comprising if a request for a service is input while displaying the detailed information, providing the requested service.

14. A method for searching for information in a mobile terminal, the method comprising:
if a place search word is input in a search mode, transmitting the place search word to a retrieval system via a network;
displaying found place information received from the retrieval system; and
if the displayed place information is selected, performing a communication service using the selected place information.

15. The method of claim 14, wherein the place search word includes a search location.

16. The method of claim 15, wherein the place search word further includes one of a trade name and an activity type.

17. The method of claim 16, wherein transmitting the place search word to a retrieval system via a network comprises:
if the place search word is one of the trade name and the activity type, transmitting a location of the mobile terminal and the place search word.

18. The method of claim 17, wherein transmitting the place search word to a retrieval system via a network comprises:
if the place search word includes the search location and one of the trade name and the activity type, transmitting the place search word.

19. The method of claim 18, wherein transmitting the place search word to a retrieval system via a network further comprises:
detecting the location of the mobile terminal.

20. The method of claim 18, wherein displaying found place information received from the retrieval system comprises:
displaying the found place information as a list.

21. The method of claim 20, wherein displaying found place information received from the retrieval system further comprises:
displaying the found place information on a map.

22. The method of claim 21, wherein performing a communication service using the selected place information comprises:
if the displayed place information is selected, displaying detailed information about a place corresponding to the selected place information; and
if the detailed information is selected, connecting with the place using the detailed information.

23. The method of claim 22, wherein the detailed information includes a phone number and wherein the connecting with the place using the detailed information is:
if the phone number is selected, making a phone call connection with the place.

24. The method of claim 23, wherein the detailed information further includes a website and wherein the connecting with the place using the detailed information further comprises:
if the website is selected, accessing the website via the network.

25. The method of claim 24, wherein transmitting the place search word to a retrieval system via a network further comprises:
displaying a search window to input the place search word.
